(19) United States
(12) Patent Application Publication
(10) Pub. No.: US 2007/0276826 A1
(43) Pub. Date: Nov. 29, 2007

(54) AGGREGATION OF AFFINITY LISTS

(75) Inventors: Jagdish Chand, Santa Clara, CA (US); Vinodh Kumar Chandra Murthy, Milpitas, CA (US)

Correspondence Address: BEYER WEAVER LLP, P.O. BOX 70250, OAKLAND, CA, 94612-0250, US

(73) Assignee: YAHOO! INC., Sunnyvale, CA (US)

(21) Appl. No.: 11/420,554

(22) Filed: May 26, 2006

(51) Int. Cl. G06F 17/30

(52) U.S. Cl. 707/6

(57) ABSTRACT

A method is provided to aggregate a plurality of affinity lists to generate a single aggregated affinity list representing predicted affinities of a particular item, to other items, under a plurality of conditions. Each of the plurality of affinity lists represents an affinity of the particular item, to other items, under a subset of the plurality of conditions that is less than all of the plurality of conditions. For each of the affinity lists, a sub-list is determined corresponding to that affinity list by determining a subset of the entries of that affinity list based on the indicated affinity, and the indicated lifts of the entries of that affinity list. For each entry of the sub-list, a normalization indication is determined for that entry. Based on the determined normalization indications, the single aggregated affinity list is generated. Each entry of the single aggregated affinity list indicates a unique one of the other items as indicated by entries in one or more of the sub-lists.

### BACKGROUND

An affinity is a measure of association between different items. A person may want to know an affinity among items in order to identify or better understand possible correlation or relationships between items such as events, interests, people or products. An affinity may be useful to predict preferences. For instance, an affinity may be used to predict that a person interested in one subject matter also is likely to be interested in another subject matter, to make an item-based recommendation.

Taking music as an example, a music recommendation engine may recognize that people who downloaded Song A also downloaded Song B. Therefore, a user X who has downloaded Song A may also be interested in downloading Song B, and Song B is recommended to user X.

In addition, it may be considered that, the more people who downloaded Song A also downloaded Song B, the more likely it is that user X would be interested in downloading Song B. A value representing the number of people who downloaded Song A and who also downloaded Song B, as a fraction of all the people who downloaded Song A, may be known as the affinity of Song B for Song A.

An affinity list may be thought of as a list of records for an item, each record indicating another item that is associated with the item and a degree of association between the other item and the first item. Extending the music example just discussed, an affinity list for Song A may have a plurality of records, each record indicating one of Song B, Song C, Song D, etc., up to Song X. Each record also indicates a degree of association between Song A and the indicated song (i.e., appropriate one of Song B, Song C, Song D, etc., up to Song X. The song(s) with the highest affinity value(s) relative to Song A may be then recommended to user X—an item-based recommendation.

The inventors have realized that it is desirable to generate personalized recommendations derived from affinity tables that might otherwise be used for item-based recommendations.

### SUMMARY

A method is provided to aggregate a plurality of affinity lists to generate a single aggregated affinity list representing predicted affinities of a particular item, to other items, under a plurality of conditions. For example, the conditions may be user characteristics.

Each of the plurality of affinity lists represents an affinity of the particular item, to other items, under a subset of the plurality of conditions that is less than all of the plurality of conditions (e.g., one or a combination of user characteristics). Each affinity list includes a plurality of entries, each entry including an indication of one of the other items, an indication of an affinity of the particular item to that one of the other items under the subset of conditions to which that affinity list corresponds, and a lift indication associated with the affinity indicated in that entry.

For each of the affinity lists, a sub-list is determined corresponding to that affinity list by determining a subset of the entries of that affinity list based on the indicated affinity, and the indicated lifts of the entries of that affinity list. In addition, for each entry of the sub-list, a normalization indication is determined for that entry. For example, the normalization indication may be based on the indicated affinity for an entry in view of properties of the lift indications for the entries, collectively, of that sub-list (such as maximum and minimum lift values).

Based on the determined normalization indications, the single aggregated affinity list is generated. Each entry of the single aggregated affinity list indicates a unique one of the other items as indicated by entries in one or more of the sub-lists.

### BRIEF DESCRIPTION OF THE DRAWINGS

FIG. 1 is a flow chart illustrating processing the affinity lists in accordance with a broad aspect.

FIG. 2 graphically illustrates, using an abstract example, the processing of the FIG. 1 flowchart.

FIG. 3 is a flowchart that graphically illustrates, in one example, how the step 102 processing (FIG. 1) may be carried out on an affinity list in several steps.

FIG. 4 shows an example of the result of the processing in the steps of the FIG. 3 flowchart.

FIG. 5 illustrates an example configuration of a system in which the FIG. 1 method may operate.

### DETAILED DESCRIPTION

The general concept of item-based recommendations, based on affinity, has been discussed in the background. While affinity is a measure of prevalence of a second item in association with a first item, lift is also a measure of the relative prevalence of the first item with the second item, but also taking into account the popularity of the second item. Put another way, lift is a measure of the extent to which the conditional probability of the second item occurring relates to the overall unconditional probability of the second item occurring. When lift is considered, a very popular “other item” will not skew the recommendation.

The inventors have discovered that, by considering both affinity and lift values, a plurality of affinity lists (which, for example, might be used to generate item-based recommendations) can be advantageously aggregated, to generate a personalized recommendation. For example, a given user may have associated with it multiple characteristics such as demographic, location, interest and content consumption of specific category. Basically, in accordance with one aspect, each affinity list is separately normalized, and then the normalized affinity lists are combined into the aggregated affinity list. Thus, for example, personalized recommendations may be made that account for multiple characteristics of the user.

In accordance with a broad aspect, a plurality of affinity lists are processed. Each affinity list corresponding to a different characteristic. Further, each affinity list indicates, relative to the characteristic to which that affinity list corresponds, items having an affinity to a particular item. Each entry in an affinity list includes an affinity indication relative to one item having an affinity to the particular item and, also, includes a lift indication associated with that indicated affinity.

Thus, for example, Ryan is a 19-year old male likes to listen to different kinds of music. One of Ryan's favorite artists is Nirvana. It is desired to recommend other artists to Ryan. Three sets of music affinity data are considered, grouped by the following criteria:

User Artist ratings

User age group

User gender (male/female/unknown)

From the three sets of music affinity data, only some entries are of interest with respect to the particular recommendation for Ryan. Namely, the entries of interest are for artists who have an affinity with Nirvana, artists who are liked by the 15-20 year age group, and artists who are liked by male users. These sets (affinity lists) may be designated as S1, S2 and S3, respectively. Example entries in the sets are shown below.

S1 (for Nirvana to Artist)={(‘Nirvana’, ‘Jimi Hendrix’, aff=98, lift=0.62), (‘Nirvana’, ‘Metallica’, 90, 0.55),(‘Nirvana’, ‘Guns' n Roses’, 99, 0.7), (‘Nirvana’, ‘Britney Spears’, 10, 0.1)}

S2 (for 15-20 yr age group) to Artist={((15-20 yr), ‘Jimi Hendrix’, 78, 0.6), ((15-20 yr), ‘Britney Spears’, 77, 0.8), ((15-20 yr), ‘Queen’, 55, 0.5), ((15-20 yr), ‘Metallica’, 85, 0.8), ((15-20 yr), ‘50 cents’, 76, 0.73)}

S3 (for Male user to Artist)={(male, ‘Britney Spears’, 8, 0.25), (male, ‘Jimi Hendrix’, 78, 0.9), (male, ‘Matchbox 20’, 77, 0.85), (male, ‘Queen’, 67, 0.57), (male, ‘Metallica’, 83, 0.82), (male, ‘50 cents’, 79, 0.76)}

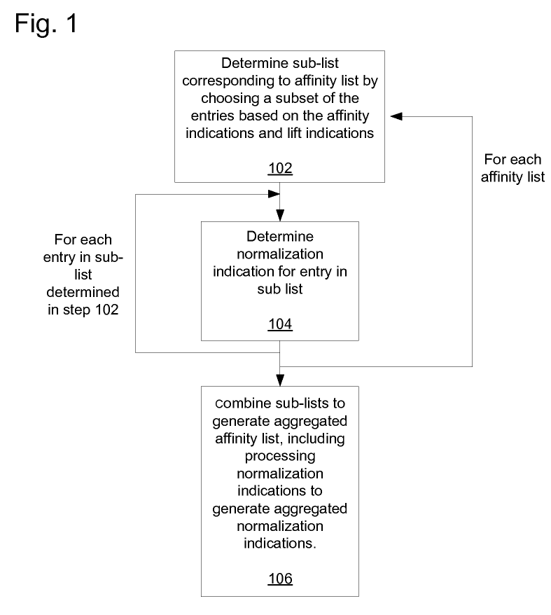

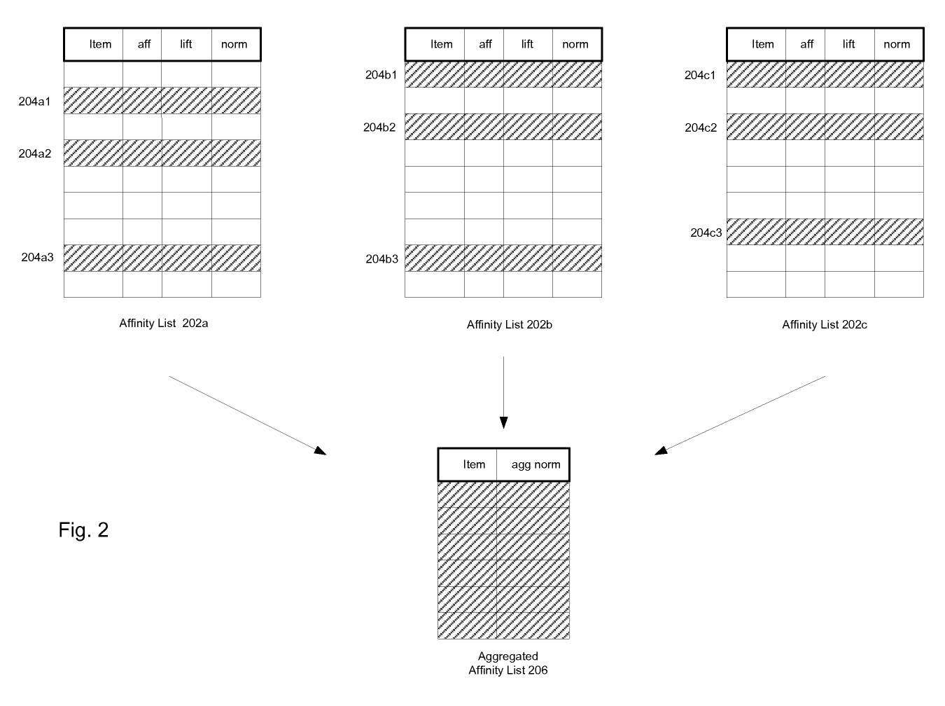

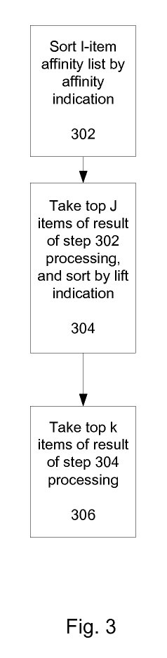

FIG. 1 is a flow chart illustrating processing the affinity lists in accordance with a broad aspect. After describing FIG. 1, an implementation illustrated in FIGS. 2 and 3 is discussed, including incorporating the example of Ryan set forth above. Turning now to FIG. 1, steps 102 and 104 are carried out on each affinity list (such as the affinity lists S1, S2 and S3, discussed above).

At step 102, a subset of entries of the affinity list (e.g., S1)—a “sub list—is chosen based on the affinity indications and the lift indications of the records. As a preview, in the implementation illustrated in FIGS. 2 and 3, step 102 includes first determining a subset of j entries based on the affinity indications and then determining a subset of k entries (of the j entries) based on the lift indications.

At step 104, a normalization indication is determined for each entry in each sub-list. In one example, the normalization indication is an “inverse distance” determined, for the entries in a particular sub-list, using (in part) minimum and maximum lift values for that sub-list. For example, the inverse distance for a particular entry may be computed as follows:

dm=(liftm−min_lifti)/max_lifti

where liftm is the lift indication for the particular entry, min_lifti is the lowest lift indication for any entry in the sub-list to which the particular entry belongs, and max_lifti is the highest lift indication for any entry in the sub-list to which the particular entry belongs. In general, then, the inverse distance normalized lift indication is an indication of how the particular entry compares to other entries in the sub-list, relative to the lift indications for those entries.

At step 106, the sub-lists (from step 102) are combined to generate an aggregated list, including processing the normalization indications to generated aggregated normalization indications. More particularly, where a particular item appears in more than one sub-list (e.g., using the example of Ryan discussed later, “Metallica” appears in all of sub-lists S1, S2 and S3), the normalization indications for the particular item in all of the sub-lists are processed to generate an aggregated normalization indication for that particular item. In some examples (e.g., in some instances where the normalization indication is an inverse distance), the aggregated normalization indication for an item is simply the sum of all the normalization indications for that item, wherever it appears in an entry of one of the sub-lists.

FIG. 2 graphically illustrates, using an abstract example, the processing of the FIG. 1 flowchart. Referring to FIG. 2, the affinity lists referred to in FIG. 1 are represented by the Affinity List 202a, the Affinity List 202b and the Affinity List 202c (generically, indicated by reference numeral 202). The affinity and lift values for the items in these affinity lists are indicated in the “aff” and “lift” columns, respectively. The items of the sub-list for each Affinity List 202 are indicated by the hatch marks. For example, the items of the sub-list for Affinity List 202a are the hatched items 204a1, 204a2 and 204a3. Similarly, the items of the sub-list for Affinity List 202b are the hatched items 204b1, 204b2 and 204b3; and the items of the sub-list for Affinity List 202c are the hatched items 204c1, 204c2 and 204c3.

The normalization indications are indicated in the “norm” columns in FIG. 2. The Aggregated Affinity List 206 represents the result of the step 106 processing. In the FIG. 2 illustration, it can be seen that each sub-list has three items (i.e., there are three hatched items in each of Affinity List 102a, Affinity List 102b and Affinity List 102c). The Aggregated Affinity List 106, on the other hand, has six items (not nine, or three times three, items). This is because, for some of the hatched items, the item indication is the same.

For example, using the example of Ryan above, a hatched item in each of these lists may have an item indication of “Metallica.” However, only one of the items in the Aggregated Affinity List 206 (and not three) has an item indication of “Metallica.” The aggregated normalization indication (in the “agg norm” column), generated by processing the normalization indication for the Metallica entry in the Affinity List 202a, in the Affinity List 202b and in the Affinity List 202c, may be used to rank the “Metallica” item as among the other items in the Aggregated Affinity List 206.

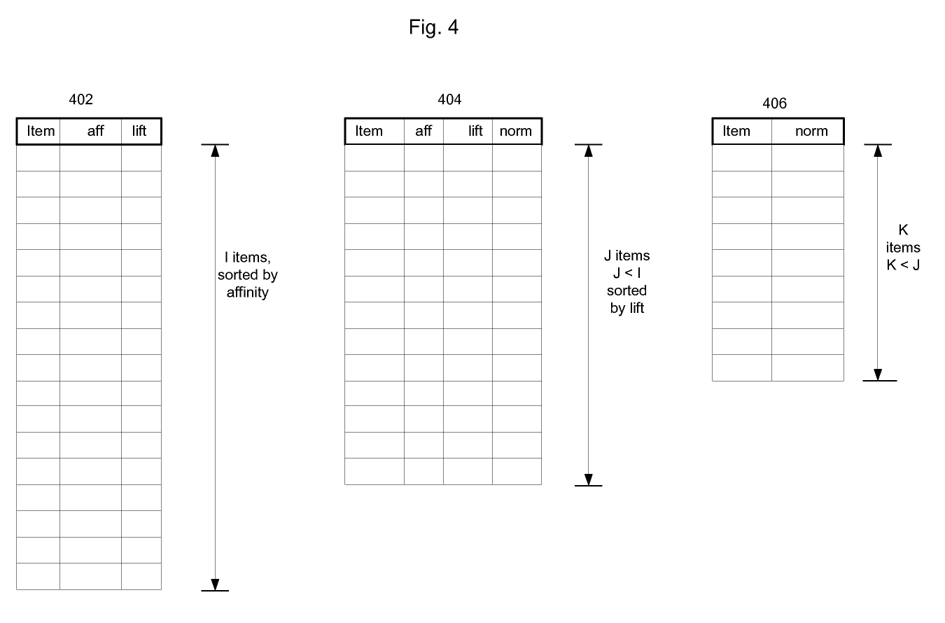

FIG. 3 is a flowchart that graphically illustrates, in one example, how the step 102 processing (FIG. 1) may be carried out on an affinity list in several steps. FIG. 4 shows an example of the result of the processing in the steps of the FIG. 3 flowchart. Turning to FIG. 3, step 302 includes processing to sort an I-item affinity list, by affinity indication. Step 304 includes processing to take the top J items (by affinity indication) of the I-item affinity list, and sort those J items by lift indication. Finally, step 306 includes processing to take the top K items (by lift indication) of the J-item list. The result of the step 306 processing is the sub-list determined in step 102 (FIG. 1).

Turning to FIG. 4, this figure graphically illustrates an example of the FIG. 3 processing. The list 402 represents an I item list, sorted by affinity indication—a result of the step 302 (FIG. 3) processing. The list 404 represents the top J items of the list 402, and sorted by lift indication—a result of the step 304 processing. Finally, the list 406 represents the top K items of the list 404. Assuming the normalization indication, in the “norm” column of list 406, has been determined, this would correspond to the result of the step 104 (FIG. 1) processing.

We now discuss the particular example of Ryan, introduced above. As introduced above, Ryan is a 19 year old male likes to listen to different kinds of music. One of Ryan's favorite artists is Nirvana. It is desired to recommend other artists to Ryan. Three sets of music affinity data are considered, described above as being designated S1, S2 and S3.

First, the top one hundred items are taken from each of S1, S2 and S3, based on the affinity score (J-100). These one hundred items are sorted based on lift score, and the top twenty are taken (K=20). This corresponds, for example, to step 102 in FIG. 1; to steps 302, 304 and 306 in FIG. 3; and to lists 402, 404 and 406 in FIG. 4 (noting that FIGS. 3 and 4 are directed to a single list, such as S1, S2 or S3, but not to all the lists collectively).

These resultant sets—designated as S1′, S2′ and S3′—are used in the aggregating step based on the determined normalization indications. For example, let S1′={(‘Nirvana’, ‘Guns' n Roses’, 99, 0.7), (‘Nirvana’, ‘Nine Inch Nails’, 87, 0.68), (‘Nirvana’, ‘Jimi Hendrix’, 98, 0.62), (‘Nirvana’, ‘Metallica’, 90, 0.55), (‘Nirvana’, ‘Pearl Jam’, 67, 0.44)}. Let S2′=((15-20 yr), ‘Metallica’, 85, 0.8), ((15-20 yr), ‘Britney Spears’, 77, 0.8), ((15-20 yr), ‘50 cents’, 76, 0.73), ((15-20 yr), ‘Jimi Hendrix’, 78, 0.6), ((15-20 yr), ‘Queen’, 55, 0.5)}. Let S3′={(male, ‘Jimi Hendrix’, 78, 0.9), (male, ‘Matchbox 20’, 77, 0.85), (male, ‘Metallica’, 83, 0.82), (male, ‘50 cents’, 79, 0.76), (male, ‘Queen’, 67, 0.57)}.

Let (min_lift=0.44, max_lift=0.7)1, (0.5, 0.8)2 and (0.57, 0.9)3 be the minimum and maximum lift scores in S1′, S2′ and S3′ respectively. The inverse distances for each of the twenty entries is computed to form the sets S1″, S2″ and S3″. The resultant sets S1″, S2″ and S3″ are the following (where “d” is the inverse distance for a particular entry): S1″={(‘Nirvana’, ‘Guns' n Roses’, d=0.371), (‘Nirvana’, ‘Nine Inch Nails’, 0.343), (‘Nirvana’, ‘Jimi Hendrix’, 0.257), (‘Nirvana’, ‘Metallica’, 0.157), (‘Nirvana’, ‘Pearl Jam’, 0.0)}. S2″={((15-20 yr), ‘Metallica’, 85, 0.375), ((15-20 yr), ‘Britney Spears’, 77, 0.375), ((15-20 yr), ‘50 cents’, 76, 0.286), ((15-20 yr), ‘Jimi Hendrix’, 78, 0.125), ((15-20 yr), ‘Queen’, 55, 0.0)}. S3″={(male, ‘Jimi Hendrix’, 78, 0.367), (male, ‘Matchbox 20’, 77, 0.311), (male, ‘Metallica’, 83, 0.278), (male, ‘50 cents’, 79, 0.211), (male, ‘Queen’, 67, 0.0)}

For all the artists that are present in more than one of S1″, S2″ and S3″, the inverse distances are summed, and those artists are added to the aggregated list. For example, for Metallica, d=0.157+0.375+0.278=0.81. For ‘50 cents’, d=0.286+0.211=0.497. For those artists present in only one of S1″, S2″ and S3″, the entry for each of those artists are added to the aggregated list as well, with the aggregated inverse distance being merely the inverse distance for that entry. The aggregated list is sort based on the aggregated inverse distances. Continuing on with the example of Ryan, then, the final ranked aggregated list is:

| | |
|---|---|
| ‘Metallica’ | 0.812 |
| ‘Jimi Hendrix’ | 0.7493 |
| ‘50 cents’ | 0.4974 |
| ‘Britney Spears’ | 0.3755 |
| ‘Guns’n Roses’ | 0.3716 |
| ‘Nine Inch Nails’, | 0.3437 |
| ‘Matchbox 20’, | 0.311 |

That is, based on Ryan's characteristics, the behavior of other users having at least one or more of those characteristics, and Ryan's interest in Nirvana, this final ranked-aggregated list may serve as a basis for making recommendations to Ryan of other artists in which Ryan is likely to be interested.

In general, then, by considering both affinity and lift values, a plurality of affinity lists (which, for example, might be used to generate item-based recommendations) can be advantageously aggregated, to generate a personalized recommendation.

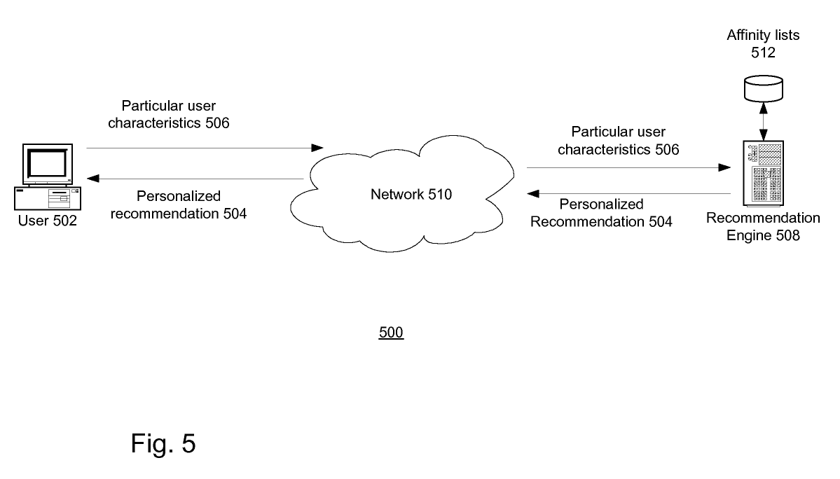

FIG. 5 illustrates an example configuration of a system 500 in which the described method may operate. The user 502 is a user, such as Ryan in the example above, to whom it is desired to make a personalized recommendation 504. The user 502 has particular user characteristics 506 which are provided to a recommendation engine 508 via a network 510. For example, the particular user characteristics of Ryan include, as discussed above, Ryan's favorite artist, age group, and gender.

Meanwhile, the recommendation engine 508 has available to it a plurality of affinity lists 512 which have been generated based on the characteristics and activities of users generally. Using the example of Ryan again, these affinity lists 512 may include affinity lists S1, S2 and S3. Based on the particular user characteristics 506 and the affinity lists 512, the recommendation engine 508 aggregates appropriate ones of the affinity lists 512 and generates the personalized recommendation 504, which is provided back to the user 502 via the network 510. For example, the personalized recommendation 504 may be merely a list including the entries of the aggregated affinity list generated by the recommendation engine 508.

Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the claims.

What is claimed is:

1. A method of aggregating a plurality of affinity lists to generate a single aggregated affinity list representing predicted affinities of a particular item, to other items, under a plurality of conditions, each of the plurality of affinity lists representing an affinity of the particular item, to other items, under a subset of the plurality of conditions that is less than all of the plurality of conditions, wherein each affinity list includes a plurality of entries, each entry including an indication of one of the other items, an indication of an affinity of the particular item to that one of the other items under the subset of conditions to which that affinity list corresponds, and a lift indication associated with the affinity indicated in that entry, the method comprising:
for each of the affinity lists
determining a sub-list corresponding to that affinity list by determining a subset of the entries of that affinity list based on the indicated affinity, and the indicated lifts of the entries of that affinity list; and
for each entry of the sub-list, determining a normalization indication for that entry; and
based on the determined normalization indications, generating the single aggregated affinity list, including a plurality of entries, each of the plurality of entries of the single aggregated affinity list indicating a unique one of the other items as indicated by entries in one or more of the sub-lists.

2. The method of claim 1, wherein:
generating the single aggregated affinity list based on the determined normalization includes:
for each unique one of the other items indicated by entries in one or more of the sub-lists, processing the determined normalization indications for those entries to determine an aggregated normalization indication for that unique item; and
generating the single aggregated affinity list to include entries indicating at least some of the unique items, wherein the aggregated normalization indication for each unique item indicates a predicted affinity of the particular item, to that unique item, under the plurality of conditions.

3. The method of claim 2, wherein:
processing the determined normalization indications for those entries, for each unique item, to determine an aggregated normalization indication for that unique item includes summing the determined normalization indications for those entries for that unique item.

4. The method of claim 1, wherein:
determining a normalizing indication for an entry in one of the plurality of sub-lists comprises processing the indicated affinity for that entry in view of properties of the lift indications for the entries of that sub-list.

5. The method of claim 4, wherein:
the properties of the lift indication for the entries of that sub-list, in view of which the indicated affinity for that entry is processed, include maximum and minimum values of lift indications for the entries, collectively, of that sub-list.

6. The method of claim 1, further comprising:
determining, for each affinity list, which of the entries of that affinity list are to have corresponding entries in the sub-list for that affinity list, including:
removing from consideration, from having corresponding entries in the sub-list, each entry whose affinity indication indicates the affinity of the particular item to the item indicated in that particular entry is below a particular threshold;
for the remaining entries, removing from consideration, from having corresponding entries in the sub-list, each entry whose lift indication indicates the lift associated with the affinity indicated by that entry is below a particular threshold.

7. The method of claim 6, wherein:
the affinity for an entry being below a particular threshold includes the affinity for that entry not being in a top predetermined number of affinities for the entries, collectively, of the affinity list; and
the lift indication for an entry being below a particular threshold includes the lift for that entry not being in a top predetermined number of lifts for the remaining entries, collectively, of the affinity list.

8. The method of claim 1, wherein:
the plurality of conditions are characteristics of a particular user; and
the method further comprises generating at least one recommendation to that particular user based on the single aggregated affinity list.

9. The method of claim 1, wherein:
determining a sub-list corresponding to that affinity list includes:
considering a predetermined number of entries of the affinity list, having the highest affinity values, to determine a first iteration of the sub-list; and
considering a predetermined number of entries of the first iteration of the sub-list, having the highest lift indications.

10. A computing device operable to perform the method of claim 1.

11. A method of operating a computing device to provide a personalized recommendation to a user, the method comprising:
based on characteristics of the user, determining a plurality of affinity lists corresponding to those characteristics;
aggregating the plurality of affinity lists to generate a single aggregated affinity list representing predicted affinities of a particular item, to other items, under a plurality of conditions, each of the plurality of affinity lists representing an affinity of the particular item, to other items, under a subset of the plurality of conditions that is less than all of the plurality of conditions, wherein each affinity list includes a plurality of entries, each entry including an indication of one of the other items, an indication of an affinity of the particular item to that one of the other items under the subset of conditions to which that affinity list corresponds, and a lift indication associated with the affinity indicated in that entry, including
for each of the plurality of affinity lists
determining a sub-list corresponding to that affinity list by determining a subset of the entries of that affinity list based on the indicated affinity, and the indicated lifts of the entries of that affinity list; and
for each entry of the sub-list, determining a normalization indication for that entry; and
based on the determined normalization indications, generating the single aggregated affinity list, including a plurality of entries, each of the plurality of entries of the single aggregated affinity list indicating a unique one of the other items as indicated by entries in one or more of the sub-lists; and
providing the personalized recommendation to the user based on the single aggregated affinity list.

12. The method of claim 11, wherein:
generating the single aggregated affinity list based on the determined normalization includes:
for each unique one of the other items indicated by entries in one or more of the sub-lists, processing the determined normalization indications for those entries to determine an aggregated normalization indication for that unique item; and
generating the single aggregated affinity list to include entries indicating at least some of the unique items, wherein the aggregated normalization indication for each unique item indicates a predicted affinity of the particular item, to that unique item, under the plurality of conditions.

13. A method of generating a personalized recommendation to a user, comprising:
based on characteristics of the user, determining appropriate ones of a plurality of affinity lists;
aggregating the determined appropriate ones of the plurality of affinity lists, to generate a single aggregated affinity list; and
processing the single aggregated affinity list to generate the personalized recommendation.

14. A computer program product for aggregating a plurality of affinity lists to generate a single aggregated affinity list representing predicted affinities of a particular item, to other items, under a plurality of conditions, each of the plurality of affinity lists representing an affinity of the particular item, to other items, under a subset of the plurality of conditions that is less than all of the plurality of conditions, wherein each affinity list includes a plurality of entries, each entry including an indication of one of the other items, an indication of an affinity of the particular item to that one of the other items under the subset of conditions to which that affinity list corresponds, and a lift indication associated with the affinity indicated in that entry, the computer program product comprising at least one computer-readable medium having computer program instructions stored therein which are operable to cause at least one computing device to
for each of the affinity lists
determine a sub-list corresponding to that affinity list by determining a subset of the entries of that affinity list based on the indicated affinity, and the indicated lifts of the entries of that affinity list; and
for each entry of the sub-list, determine a normalization indication for that entry; and
based on the determined normalization indications, generate a single aggregated affinity list, including a plurality of entries, each of the plurality of entries of the single aggregated affinity list indicating a unique one of the other items as indicated by entries in one or more of the sub-lists.

15. The computer program product of claim 14, wherein:
the computer program instructions operable to cause the at least one computing device to generate the single aggregated affinity list based on the determined normalization includes:
for each unique one of the other items indicated by entries in one or more of the sub-lists, causing the computer to process the determined normalization indications for those entries to determine an aggregated normalization indication for that unique item; and
causing the at least one computing device to generate the single aggregated affinity list to include entries indicating at least some of the unique items, wherein the aggregated normalization indication for each unique item indicates a predicted affinity of the particular item, to that unique item, under the plurality of conditions.

16. The computer program product of claim 14, wherein:
the computer program instructions operable to cause the at least one computing device to generate the determined normalization indications for those entries includes instruction to cause the at least one computer device to, for each unique item, determine an aggregated normalization indication for that unique item includes summing the determined normalization indications for those entries for that unique item.

17. The computer program product of claim 14, wherein:
the computer program instructions operable to cause the at least one computing device to determine a normalizing indication for an entry in one of the plurality of sub-lists comprises computer program instructions operable to cause the at least one computing device to process the indicated affinity for that entry in view of properties of the lift indications for the entries of that sub-list.

18. The computer program product of claim 17, wherein:
the properties of the lift indication for the entries of that sub-list, in view of which the indicated affinity for that entry is processed, include maximum and minimum values of lift indications for he entries, collectively, of that sub-list.

19. The computer program product of claim 14, further comprising computer program instructions operable to cause the at least one computing device to:
determine, for each affinity list, which of the entries of that affinity list are to have corresponding entries in the sub-list for that affinity list, including to:
remove from consideration, from having corresponding entries in the sub-list, each entry whose affinity indication indicates the affinity of the particular item to the item indicated in that particular entry is below a particular threshold;
for the remaining entries, to remove from consideration, from having corresponding entries in the sub-list, each entry whose lift indication indicates the lift associated with the affinity indicated by that entry is below a particular threshold.

20. The method of claim 10, wherein:
the affinity for an entry being below a particular threshold includes the affinity for that entry not being in a top predetermined number of affinities for the entries, collectively, of the affinity list; and
the lift indication for an entry being below a particular threshold includes the lift for that entry not being in a top predetermined number of lifts for the remaining entries, collectively, of the affinity list.

21. The computer program product of claim 14, wherein:
the plurality of conditions are characteristics of a particular user; and
the computer program product further comprises computer program instructions operable to cause the at least one computing device to generate at least one recommendation to that particular user based on the single aggregated affinity list.

22. The computer program product of claim 14, wherein the computer program instructions operable to cause the at least one computing device to determine a sub-list corresponding to that affinity list includes computer program instructions operable to cause the at least one computing device to:
consider a predetermined number of entries of the affinity list, having the highest affinity values, to determine a first iteration of the sub-list; and
consider a predetermined number of entries of the first iteration of the sub-list, having the highest lift indications.
